(19) United States
(12) Patent Application Publication
(10) Pub. No.: US 2006/0120496 A1
(43) Pub. Date: Jun. 8, 2006

(54) Receiving apparatus

(75) Inventor: Jun-ichi Okamura, Tokyo (JP)

Correspondence Address: MICHAUD-DUFFY GROUP LLP, 306 INDUSTRIAL PARK ROAD, SUITE 206, MIDDLETOWN, CT, 06457, US

(73) Assignee: Thine Electronics, Inc., Tokyo (JP)

(21) Appl. No.: 10/533,056

(22) PCT Filed: Oct. 30, 2003
(86) PCT No.: PCT/JP03/13941

§ 371 Date: Oct. 3, 2005

(30) Foreign Application Priority Data
Oct. 31, 2002 (JP) 2002-318806

(51) Int. Cl. H04L 7/00

(52) U.S. Cl. 375/355; 375/371

(57) ABSTRACT

A receiver apparatus having a demodulator circuit that demodulates transmitted serial data into parallel data by sampling the transmitted serial data on the basis of a first and a second clock signals having different numbers of clocks to be output in synchronization with a cycle of a transmitted clock includes a first synchronizing circuit that generates the first clock signal synchronized with the cycle of the transmitted clock, and a second synchronizing circuit that generates the second clock signal synchronized with the cycle of the transmitted clock and having a number of clocks different from the first clock signal. The demodulator circuit comprises the second synchronizing circuit, a sampling register that samples the transmitted serial data on the basis of the first and second clock signals, a difference calculating circuit that calculates a difference relative to the input clock signal of the transmitted serial data on the basis of a sampled data sampled by the sampling register, and a clock select circuit that adjusts a phase of a symbol-sampled signal on the basis of the difference.

### BACKGROUND OF THE INVENTION

1. Field of the Invention

This invention generally relates to receiving apparatuses of the serial digital transmission signals, and more particularly, to a receiving apparatus for use in demodulation of transmitted serial data.

Recent years, an apparatus having a receiver circuit used for high-speed digital transmission signals generally employs a scheme for sampling serial data with the use of sampled clock signals of equal-phase symbol in synchronization with the transmitted clock signals equal in number to the serialized symbol bits, at the time of demodulating the data.

On the other hand, the demodulator circuit of the above-mentioned simple sampling scheme has a problem in that the symbol data cannot be demodulated completely, even in sampling the transmission data properly with the use of the symbol-sampled clock signal, if the data phase deviates from the symbol-sampled clock signal due to an uneven signal delay on the transmission line (skew) or the waveform of the transmission signal is degraded due to the uneven signal delay between the balanced transmission lines. The circuit technique is therefore important for the apparatus having the receiver circuit for the high-speed serial digital transmission signals so that even thus degraded received signal can be demodulated stably.

2. Description of the Related Art

The demodulator circuit of the sampling scheme in recent years employs an oversampling method as an effective one, which has sampling points more than the number of the symbol bits in order to demodulate the received data stably although the signal waveform is degraded on the transmission line.

U.S. Pat. No. 5,802,103, for example, discloses an example of the fully duplexed transmission device that demodulates the received data with the oversampling scheme in the high-speed serial transmission. Hereinafter, this patent is referred to as conventional technique 1.

FIG. 1 is a block diagram of a configuration of a receiver circuit 1000 that employs the oversampling scheme of the conventional technique 1. In FIG. 1, data blocks is composed of eight bits, and shows an example in which the sampling rates are equal in number to three times the bit rates of the transmitted serial data.

As shown in FIG. 1, the receiver circuit 1000 includes a synchronizing circuit (DLL/PLL) 100, a sampling register 110, and a logical value decision circuit 120. The synchronizing circuit 100 receives an input clock signal 101, and generates multiphase clock signals 102 having the sampling rates three times the bit rates of a transmitted serial data 111. The sampling register 110 oversamples the transmitted serial data 111 with the multiphase clock signals 102. The logical value determination circuit 120 determines an eight-bit symbol value 122 included in one data block on the basis of the oversampled result.

On this configuration, one data block (eight bits) of the transmitted serial data 111, input into the sampling register 110, is oversampled at 24-bit sampling points, which is equal in number to three times the symbol bits, and is then output as 24-bit parallel data 112.

The logical value determination circuit 120 calculates the probability with the 24-bit parallel data 112 outputs from the sampling register 110 to obtain a transition point of the transmitted serial data 111. Further, the logical value determination circuit 120 appropriately determines the eight-bit symbol value 122 from among the 24-bit parallel data 112 obtained by oversampling on the basis of the obtained transition points.

A description will be given of the operation of the receiver circuit 1000 with reference to a logical value shown in FIG. 2. In FIG. 2, a data block 200, which is one of transmitted serial data 111 input into the receiver circuit 1000, is oversampled by the multiphase clock signals 102 having a frequency equal to three times the bit rates of the input clock signal 101, resulting in the output as the 24-bit parallel data 112 in which the logical value of the transmitted serial data 111 is reflected.

In conventional technique 1, the logical value is calculated by the probability with thus output parallel data 112, and then transition points 201 through 205 are determined. Here, the existence of one transition point is determined in such a manner that the same logical value appears twice in a row, for example, in the sampled parallel data 112. The eight-bit symbol value 122 is determined from among the 24-bit parallel data 112 on the basis of thus determined transition point.

Accordingly, with respect to the data phase, the three-time over sampling scheme employed by conventional technique 1 allows ±30 phase lags at maximum in a symbol period (an inverse number of a clock frequency multiplied by the number of the symbol bits).

The oversampling scheme, however, generally has a problem in that the necessary area and the power consumption are more required and increased in the semiconductor integrated circuit as the number of the sampling clock signals and the number of the sampling circuits increase. This problem can be solved by employing equal to or more than three to four times of the oversampling scheme with further process technology, yet there arises another problem in that the production cost will be increased.

Pamphlet of International Publication 02/0656902, for example, discloses the semiconductor integrated circuit that solves the above-mentioned problems. Hereinafter, this is referred to as conventional technique 2.

Conventional technique 2 employs two types of clock signals having different numbers of clocks to be output in synchronization with cycles of a transmitted clock, and makes it possible to stably detect the symbol value of the transmitted serial data that has been received. The number of the sampling clock signals or the number of the sampling circuits do not have to be increased even if the data phase of the transmitted serial data is deviated from the symbol sampling clock signal or the waveform of the transmission data is degraded due to the uneven signal delay on the transmission line. More specifically, from between the two types of the clock signals in synchronization with the cycle of the transmitted clock, a first group of multiphase clock signals is used for measuring the phase alignment of the transmitted serial data, and a second group of the multiphase clock signals is used for measuring the phase alignment of the transmitted serial data and obtaining the symbol value of the transmitted serial data. The phases of the second group of multiphase clock signals are adjusted by the measurement result of the phase alignment that has been obtained. This can maintain the phases of the sampling clock signals always appropriate for the transmitted serial data, resulting in the above-mentioned effect.

A description will be given, with the reference to FIG. 3, of a configuration of a receiver circuit 2000 for the high-speed serial digital transmission line that employs the semiconductor integrated circuit of conventional technique 2. FIG. 3 shows functional blocks in which the receiver circuit 2000 is applied to a three-channel high-speed digital receiver. In FIG. 3, the symbol bits are configured to have 10 bits, and this realizes the phase-adjusting capabilities of equal to or more than four times the oversampling method.

In FIG. 3, the receiver circuit 2000 includes a common circuit 2 and multiple (three in FIG. 3) demodulator circuits 3a, 3b, and 3c. The common circuit 2 includes a first synchronizing circuit (PLL) 20.

The PLL 20 includes a phase comparator (PDF) 21, a lowpass filter (LPF) 22, and a voltage control oscillator (VCO) 23. The PLL 20 generates a clock signal 24 for measuring alignments of nine equal phases, which are synchronized with a balanced clock signal 10 (hereinafter, referred to as input clock signal) input through an analogue amplifier 60 having the gain-adjusting capabilities provided in an input circuit.

Each of the demodulator circuits 3a, 3b, and 3c (hereinafter, 3a will be described mainly) is configured to include a second synchronizing circuit (DLL) 30, a clock select circuit (SEL) 25, a sampling circuit (sampler) 28, a phase-alignment calculation circuit (calculator) 40, a decode circuit (decoder) 50, and a local buffer (BUF) 26. The DLL 30 includes a phase detector (PD) 31, a LPF 32, and a voltage control delay circuit (VCD) 33.

On the aforementioned configuration, the DLL 30 generates a symbol-sampled clock signal 34 having 10 equal-phases and outputs to a sampling circuit 28. The symbol-sampled clock signal 34 are synchronized with the input clock signal 10 on the basis of the clock signal 24 for alignment measurement, which is input by way of the clock select circuit 25 controlled by the phase-alignment calculation circuit 40. Here, the clock select circuit 25 adjusts the phase of the symbol-sampled clock signal relative to the symbol-sampled clock signal of the transmitted serial data with the use of the measurement result of the alignment. This makes it possible to maintain the phase of the symbol-sampled clock signal always most appropriate for the transmitted serial data. A clock signal 27 for measuring the alignments of nine equal phases and a balanced high-speed digital serial data (hereinafter, simply referred to as transmitted serial data) 11 are input into the sampling circuit 28, after the waveform of the clock signal 27 is shaped in the local buffer 26 and the balanced high-speed digital serial data 11 is amplified by an analogue amplifier 61. The sampling circuit 28 outputs a sampling data 29 having 18 bits (=10+9−1) based on the aforementioned input data and the clock signal.

The phase-alignment calculation circuit 40 calculates a difference in the alignment with the sampling data 29 input from the sampling circuit 28, and gives the feedback of the calculated value to the clock select circuit 25. On the other hand, the 10-bit data is sampled by the symbol-sampled clock signal 34 from among the 18-bit sampling data 29, and is output as a parallel data 51, after the bits are aligned in the decode circuit 50. The other channels (3b, 3c) are also configured and operated in the same manner.

By being configured in this manner, the receiver circuit 2000 based on conventional technique 2 is capable of demodulating the data stably, even if the phase is delayed relative to the clock signal.

The above-mentioned conventional technique 2, however, includes the channel circuit blocks having the same configuration, resulting in the increase in the circuit area in substantially proportion to the increase of the channels.

### SUMMARY OF THE INVENTION

The present invention has been made in view of the above circumstances and it is a general object of the present invention to provide a receiving apparatus in which at least a part of a circuit is shared by another circuit to avoid the increase in the whole area of the circuits.

According to one aspect of the present invention, there may be provided a receiver apparatus having a demodulator circuit that demodulates transmitted serial data into parallel data by sampling the transmitted serial data on the basis of first and second clock signals having different numbers of clocks to be output in synchronization with a cycle of a transmitted clock, said receiver apparatus including a first synchronizing circuit generating the first clock signal synchronized with the cycle of the transmitted clock, and a second synchronizing circuit generating the second clock signal synchronized with the cycle of the transmitted clock and having a number of clocks different from that of the first clock signal. The demodulator circuit may include the second synchronizing circuit, a sampling register storing sampled data obtained by sampling the transmitted serial data on the basis of the first and second clock signals, a difference calculating circuit that calculates a difference between the transmitted serial data and the input clock signal on the basis of the sampled data, and a clock select circuit that adjusts a phase of a symbol sample signal on the basis of the difference.

According to another aspect of the present invention, there may be provided a receiver apparatus having at least two demodulator circuits that demodulate transmitted serial data into parallel data by sampling the transmitted serial data on the basis of first and second clock signals having different numbers of clocks to be output in synchronization with a cycle of a transmitted clock, said receiver apparatus including a first synchronizing circuit generating the first clock signal synchronized with the cycle of the transmitted clock, and a plurality of second synchronizing circuits generating the second clock signal synchronized with the cycle of the transmitted clock and having a number of clocks different from that of the first clock signal. Each of said at least two demodulator circuits may include any one of said plurality of second synchronizing circuits, a sampling register storing sampled data obtained by sampling the transmitted serial data on the basis of the first and second clock signals, a difference calculating circuit that calculates a difference between the transmitted serial data and the input clock signal on the basis of a sampled data, and a clock select circuit that adjusts a phase of a symbol sample signal on the basis of the difference. A lowpass filter circuit included in one of said at least two modulator circuits may be shared by another modulator circuit as the lowpass filter. The above-mentioned lowpass filter having a relatively large silicon area is configured to be shared to realize the receiver apparatus in which the increase in the area is suppressed.

According to another aspect of the present invention, there may be provided a receiver apparatus including a first synchronizing circuit generating a first clock signal synchronized with a cycle of a transmitted clock, and a plurality of demodulator circuits. Each of said plurality of demodulator circuits includes a second synchronizing circuit generating the second clock signal synchronized with the cycle of the transmitted clock and having a number of clocks different from that of the first clock signal, a sampling register storing sampled data obtained by sampling the transmitted serial data on the basis of the first and second clock signals, a difference calculating circuit that calculates a difference between the transmitted serial data and the transmitted clock on the basis of the sampled data, and a clock select circuit that selects multiple clocks synchronized with the transmission clock and deviated in phase to be the input clock signal of the second synchronizing circuit, on the basis of an output from the difference calculating circuit in order to adjust a phase relation of the transmission clock while synchronized with the cycle of the transmitted clock. At least one of the second synchronizing circuit included in each of said plurality of demodulator circuits may generate the second clock signal on the basis of a controlled voltage output from a lowpass filter circuit included in the second synchronizing circuit in another demodulator circuit. The above-mentioned lowpass filter having a relatively large silicon area is configured to be shared to realize the receiver apparatus in which the increase in the area is suppressed.

According to another aspect of the present invention, there may be provided a receiver apparatus including a first synchronizing circuit generating a first clock signal synchronized with a cycle of a transmitted clock, and a plurality of demodulator circuits. Each of said plurality of demodulator circuits may include a second synchronizing circuit generating the second clock signal synchronized with the cycle of the transmitted clock and having a number of clocks different from that of the first clock signal, a sampling register storing sampled data obtained by sampling the transmitted serial data on the basis of the first and second clock signals, a difference calculating circuit that calculates a difference between the transmitted serial data and the transmitted clock on the basis of the sampled data, and a clock select circuit that selects multiple clocks synchronized with the transmission clock and deviated in phase to be the input clock signal of the second synchronizing circuit, on the basis of an output from the difference calculating circuit in order to adjust a phase relation of the transmission clock while the second synchronizing circuit is being synchronized with the cycle of the transmitted clock. At least one of the second synchronizing circuit included in each of said plurality of demodulator circuits may include a lowpass filter circuit, supplies an output from the lowpass filter circuit to another demodulator circuit, and generates the second clock signal on the basis of a controlled voltage output from the lowpass filter circuit included in the second synchronizing circuit in another demodulator circuit. The above-mentioned lowpass filter having a relatively large silicon area is configured to be shared to realize the receiver apparatus in which the increase in the area is suppressed.

According to another aspect of the present invention, there may be a receiver apparatus including a first synchronizing circuit generating a first clock signal synchronized with a cycle of a transmitted clock, a controlled voltage output circuit that outputs a controlled voltage to generate a second clock signal synchronized with the cycle of the transmitted clock and having a number of clocks different from that of the first clock signal, and a demodulator circuit that includes a second synchronizing circuit that generates a second clock signal on the basis of the controlled voltage output from the controlled voltage output circuit, a sampling register storing sampled data obtained by sampling the transmitted serial data on the basis of the first and second clock signals, a difference calculating circuit that calculates a difference between the transmitted serial data and the transmitted clock on the basis of the sampled data, and a clock select circuit selects multiple clocks synchronized with the transmitted clock and deviated in phase to be the input clock signal of the second synchronizing circuit, on the basis of an output from the controlled voltage output circuit in order to adjust a phase relation of the transmitted clock while synchronized with the cycle of the transmitted clock.

### BRIEF DESCRIPTION OF THE DRAWINGS

Preferred embodiments of the present invention will be described in detail with reference to the following drawings, wherein:

FIG. 1 is a block diagram of a configuration of a receiver circuit 1000 that employs an oversampling scheme in conventional technique 1;

FIG. 2 is a view explaining the operation of the receiver circuit 1000 shown in FIG. 1 with a logical value;

FIG. 3 shows functional blocks of a receiver circuit 2000 on a high-speed serial digital transmission line that employs a semiconductor integrated circuit of conventional technique 2;

FIG. 4 shows functional blocks showing schematic configuration of a receiver apparatus 3000 of the high-speed serial digital transmission line exemplified in the present invention;

FIG. 5 shows timing operations of the receiver circuit 3000 shown in FIG. 4 at a logical value level;

FIG. 6 shows the operation at the logical value level on the phase of the input transmitted serial data 511 that is deviated from that of the symbol-sampled clock signal 311 in the operation described in FIG. 5;

FIG. 7 shows the operation at the logical value level after the phase deviation shown in FIG. 6 is adjusted;

FIG. 8A exemplifies a required minimum sampling number and a phase adjust range of the transmitted serial data to be used in the sampling method that employs n-phase (n is a positive integer) clock signals (the clock signals generated in the first synchronizing circuit) and m-phase (m is a positive integer) clock signals (the clock signals generated in the second synchronizing circuit) in the above-mentioned receiver apparatus 3000;

FIG. 8B exemplifies another required minimum sampling number and the phase adjust range of the transmitted serial data to be used in the X-time (X is a positive integer) oversampling scheme of conventional technique 1;

FIG. 9 shows the operation at the logical value level in the phase of the input transmitted serial data deviated in an unbalanced manner from the phase of the sampling clock signals;

FIG. 10 shows the operation at the logical value level after the phase deviation shown in FIG. 9 is adjusted;

FIG. 11 shows functional blocks of a receiver circuit 4000 that receives one-channel transmitted serial data exemplified in the present invention;

FIG. 12 is a functional block diagram showing the configuration of a receiver apparatus 5000 in accordance with a first embodiment of the present invention;

FIG. 13 is a functional block diagram showing the configuration of a receiver apparatus 6000 in accordance with a second embodiment of the present invention; and

FIG. 14 is a functional block diagram showing the configuration of a receiver apparatus 7000 in accordance with a third embodiment of the present invention.

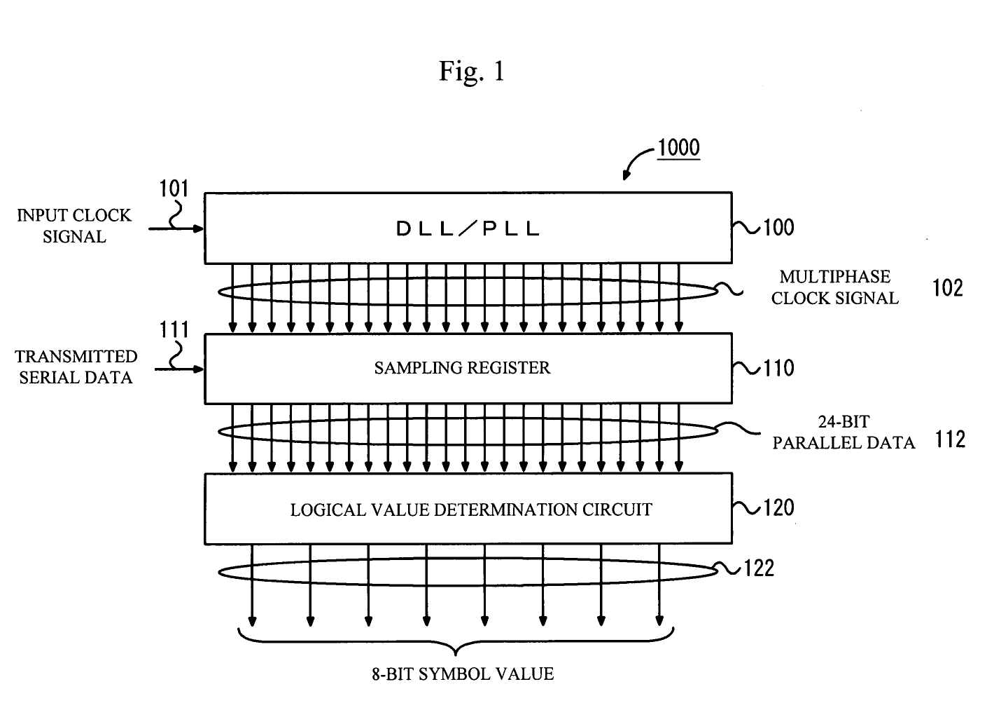

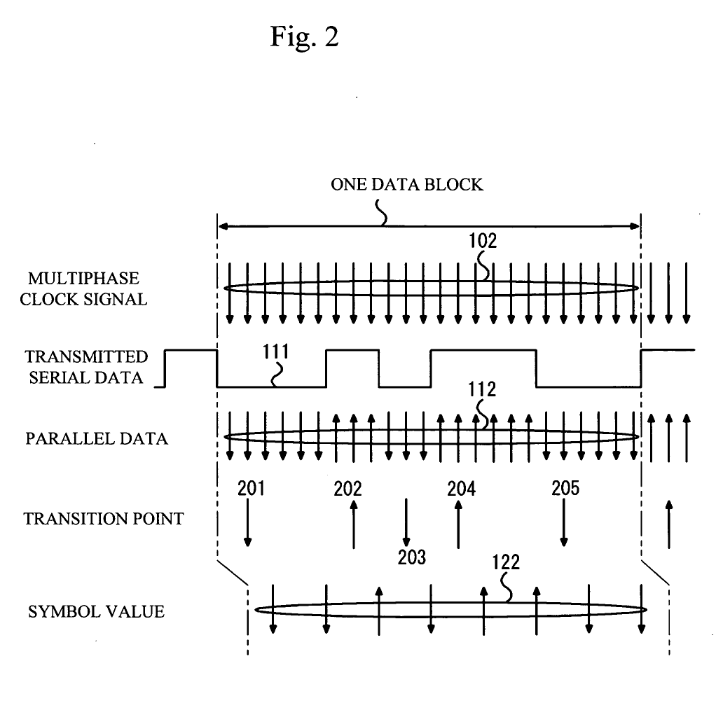

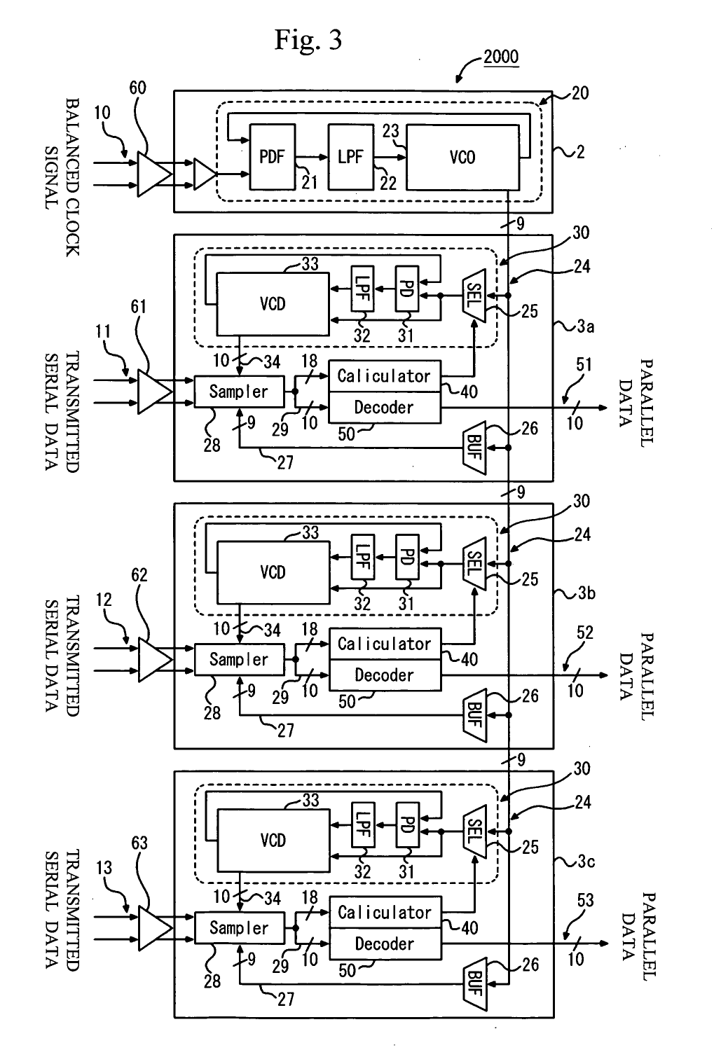

### DESCRIPTION OF THE PREFERRED EMBODIMENTS

A description will be given of an example of the basic configuration of the receiver apparatus in accordance with the present invention before giving the description of preferred embodiments of the present invention.

The basic configuration of the present invention relates, for example, to the receiver apparatus that demodulates the high-speed serial digital transmission signal, more particularly, to the receiver apparatus that can stably demodulate the received data, even if the phase of the data is deviated from the symbol-sampled clock due to the uneven signal delay on the transmission line (skew) or the waveform of the transmission signal is degraded due to the uneven signal delay between the balanced transmission lines. Conventionally, the oversampling scheme employed in the above-mentioned receiver circuit causes a problem in that the number of the sampling clocks and the number of the sampling circuits increase. The present invention realizes the receiver apparatus used for the high-speed serial digital transmission signal, in which the aforementioned problem is solved and the power consumption is low.

The receiver apparatus for the high-speed serial digital transmission signal of the present invention employs two types of equal-phase clock generators (which correspond to the first and second synchronizing circuits) having different numbers of clocks to be output in synchronization with, for example, the cycle of the transmitted clock. The two types of equal-phase clock generators generate the symbol-sampled clock signal and the clock signal used for detecting the synchronous alignment (hereinafter, referred to as the clock signal for alignment measurement). The receiver apparatus of the present invention employs two types of clock signals generated to measure the alignment relative to the symbol-sampled clock signal of the transmitted serial data, and adjusts the phase of the symbol-sampled clock signal with the use of the measurement result. This makes it possible to keep the phase always most appropriate for the transmitted serial data.

One example of the basic configuration used in the present invention can stably demodulate the received data, even in receiver the degraded data signal due to the above-mentioned causes. Moreover, the above-mentioned configuration can reduce the number of the symbol sampling clock signals and the number of the sampling circuits. Accordingly, the transmission data equal to or more than that of the oversampling scheme can be demodulated even if the number of the symbol-sampled clock signals is smaller than the sample number in the commonly used oversampling scheme.

Next, a description will be given of the receiver apparatus having the exemplified basic configuration in more detail, with reference to the accompanying drawings.

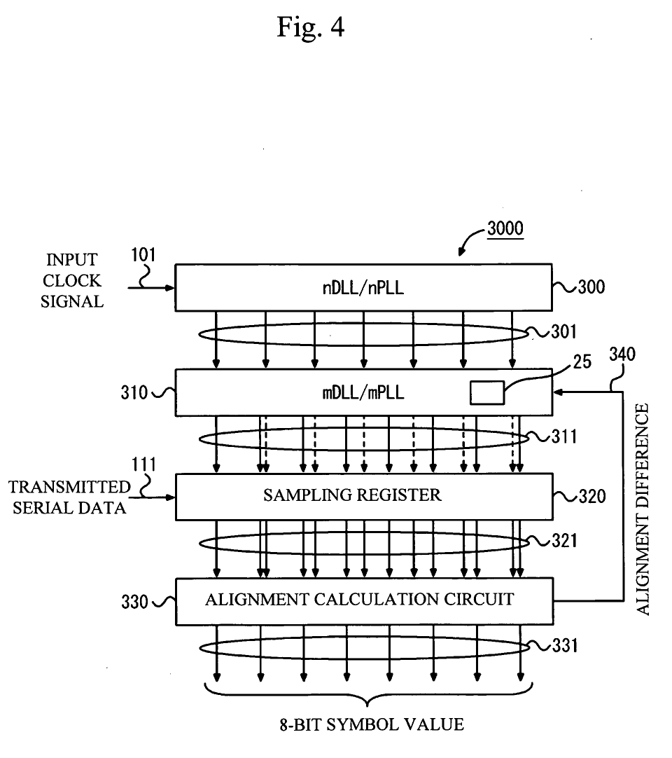

FIG. 4 is a functional block diagram showing a schematic configuration of a receiver apparatus 3000 for the high-speed serial digital transmission line, in which the exemplified basic configuration is included. In FIG. 4, the number of the symbol bits in the symbol-sampled clock signal is configured to be eight bits, thereby enabling the phase-adjusting capabilities equal to or more than those of the above-mentioned three-time oversampling scheme.

As shown in FIG. 4, the receiver circuit 3000 is configured to include a first synchronizing circuit (nDLL/nPLL) 300, a second synchronizing circuit (mDLL/mPLL) 310, a sampling register 320, and an alignment calculation circuit 330.

The first synchronizing circuit nDLL/nPLL 300 is composed of a delay locked loop (DLL) or a phase locked loop (PLL), generates a seven (=n) equal-phase clock signals 301 for alignment measurement with the input clock signal 101, and outputs to the mDLL/mPLL 310 and the sampling register 320.

The second synchronizing circuit mDLL/mPLL 310 generates a symbol-sampled clock signals 311 having eight equal-phase clocks synchronized with any one of the clock signals of the seven equal-phase clock signals 301 for alignment measurement, and outputs to the sampling register 320.

In addition to the above-mentioned seven equal-phase clock signals 301 for alignment measurement and the eight-phase symbol-sampled clock signals 311, a balanced high-speed digital transmitted serial data (hereinafter, simply referred to as transmitted serial data) 111 is input into the sampling register 320. The sampling register 320 samples the transmitted serial data 111 with 14-phase (=n+m−1: one clock signal overlaps another one) clock signals in which the two clock signals (301, 311) that have been input are overlapped (logical add). That is to say, the transmitted serial data 111 is paralleled by 1.75 times (14/8 phase) as many as the number of the symbol bits in the sampling register 320. A sampling signal 321 having 14 bits is obtained in this sampling and input into the alignment calculation circuit 330.

The alignment calculation circuit 330 calculates the probability of 1.75 times of the sampling signals 321 that has been input, and finally determines an eight-bit symbol value 331 and an alignment difference 340. Then, the alignment difference 340 is input into the mDLL/mPLL 310. The mDLL/mPLL 310 generates the symbol-sampled clock signals 311 based on the input alignment difference 340.

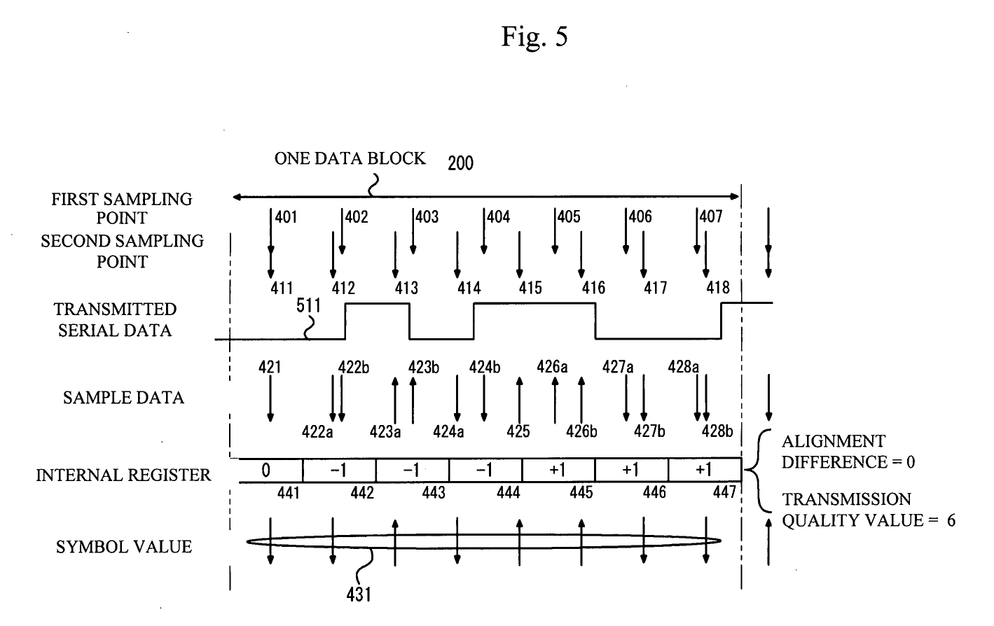

Next, a description will be given, with reference to FIG. 5, of timing operations of the receiver circuit 3000 shown in FIG. 4 at a logical value level in more detail.

In FIG. 5, a transmitted serial data 511 that has been input is sampled in the sampling register 320, with a first group of sampling points 401 through 407 and a second group of sampling points 411 through 418. The first group of sampling points 401 through 407 corresponds to seven equal-phase clock timings, which are the clock signals 301 for alignment measurement obtained by dividing the clock cycle having the symbol length of the eight symbol bits equally into seven. The second group of sampling points 411 through 418 corresponds to eight equal-phase clock timings, which are the symbol-sampled clock signals 311 obtained by dividing the clock cycle equally into eight to be synchronized with an arbitrary clock signal from among the first group of the sampling points 401 through 407. This results in 14-bit sampled data (421, 422a, 422b, 423a, 423b, 424a, 425, 426a, 426b, 427a, 427b, 428a, and 428b).

The alignment calculation circuit 330 calculates the alignment difference (340) from appropriate alignment positions with the 14-bit sampled data that has been input (421, 422a, 422b, 423a, 423b, 424a, 425, 426a, 426b, 427a, 427b, 428a, and 428b).

A description will now be given of an example of a method of calculating the alignment difference (340) relative to a proper alignment position in the transmitted serial data 511.

First, the alignment calculation circuit 330 resets to “0” at internal registers 441 through 447. Next, the alignment calculation circuit 330 judges whether the logical value of the sampled data 422a is equal to that of the sampled data 422b. If these logical values are equal, “−1” is stored in the internal register 442. In the same manner, the alignment calculation circuit 330 judges whether the logical value of the sampled data 423a is equal to that of the sampled data 423b. If these logical values are equal, “−1” is stored in the internal register 443. Further in the same manner, the alignment calculation circuit 330 judges whether the logical value of the sampled data 424a is equal to that of the sampled data 424b. If these logical values are equal, “−1” is stored in the internal register 444.

On the other hand, the alignment calculation circuit 330 judges whether the logical value of the sampled data 426a is equal to that of the sampled data 426b. If these logical values are equal, “+1” is stored in the internal register 445. In the same manner, the alignment calculation circuit 330 judges whether the logical value of the sampled data 427a is equal to that of the sampled data 427b. If these logical values are equal, “+1” is stored in the internal register 446. Further in the same manner, the alignment calculation circuit 330 judges whether the logical value of the sampled data 428a is equal to that of the sampled data 428b. If these logical values are equal, “+1” is stored in the internal register 447.

Here, the phase alignment difference 340 is calculated by totally adding the values respectively stored in the internal registers 441 through 447. That is to say, the alignment difference 340 is “0” if the transmitted serial data 511 is properly arranged in the phase alignment positions. In addition, a transmission quality value can be calculated to represent the quality on the transmission line by totally adding the absolute values respectively stored in the internal registers 441 through 447. That is, the transmission quality value of “6” denotes excellent quality on the transmission line.

Further, the alignment calculation circuit 330 demodulates an eight-bit symbol value 431 as an output signal, the eight-bit symbol value having been obtained by sampling the transmitted serial data 511 at the second group of the sampling points 411 through 418 that correspond to the symbol-sampled clock signals 311.

Next, a description will be given of another example of the method of calculating the alignment difference (340) relative to the proper alignment positions in the transmitted serial data.

In the above-mentioned example, one of “0”, “−1”, and “+1” is stored in the internal registers 441 through 447. In this example, however, “0” or “1” is stored in the internal registers 441 through 447. That is, the alignment calculation circuit 330 respectively stores “1” in the internal registers 441 through 447 if the logical values to be compared are equal in one sampling data. Then, the alignment calculation circuit 330 adds the values respectively stored in the internal registers 441 through 444 (set to SUM 1), adds the values respectively stored in the internal registers 445 through 447 (set to SUM 2), and calculates the difference (SUM 2−SUM 1). Thus, the alignment difference (340) is obtainable from the proper phase alignment positions of the transmitted serial data 511.

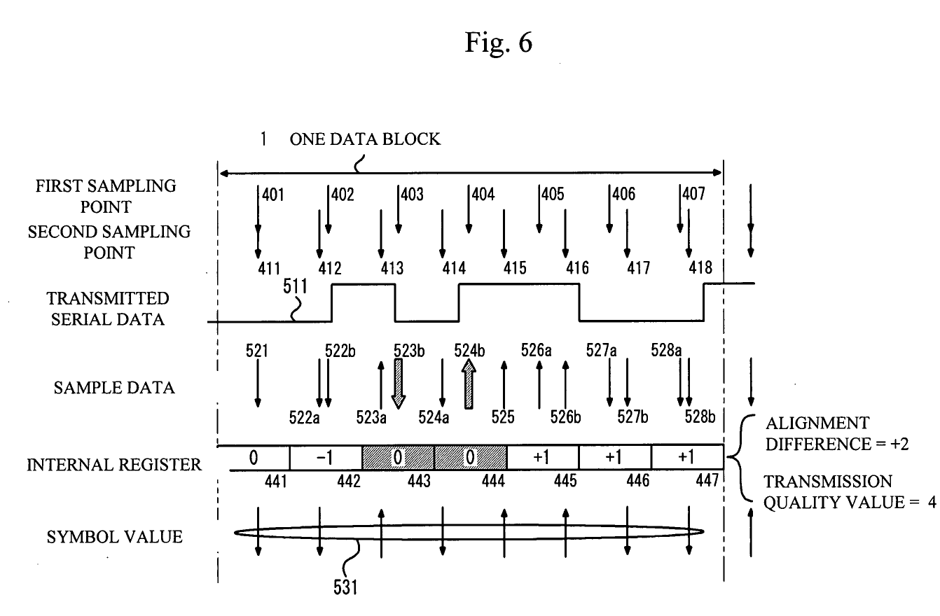

Next, a description will be given, with reference to FIG. 6, of the operation at the logical value level if the phase of the transmitted serial data 511 to be input is deviated from that of the symbol-sampled clock signal 311 in the operation described in FIG. 5. This is one of the degradation examples caused by a difference in the signal delay periods on the transmission line between the transmitted serial data 511 and the input clock signal 101.

In FIG. 6, the transmitted serial data 511 that has been input is sampled at the first group of the sampling points 401 through 407 and at the second group of the sampling points 411 through 418. One of the sampling points is commonly shared by each other. As a result, 14-bit sampled data (521, 522a, 522b, 523a, 523b, 524a, 524b, 525, 526a, 526b, 527a, 527b, 528a, and 528b) is output. In this state of the present description, the phase alignment position of the transmitted serial data 511 is deviated from the symbol-sampled clock signal 311, and accordingly, the sum of the values respectively stored in the internal registers 441 through 447 in the alignment calculation circuit 330, namely, the alignment difference 340 is “+2” instead of “0”. The mDLL/mPLL 310, therefore, adjusts the phase alignment by changing the clock signal to be selected as the reference phase from among the symbol-sampled clock signals 311 to be output. Also, the sum of the absolute values respectively stored in the internal registers 441 through 447 in the alignment calculation circuit 330, namely, the transmission quality value is “4” instead of “6”. This denotes that the quality of the transmitted serial data 511 that has been received is degraded because of the influence on the transmission line or the like.

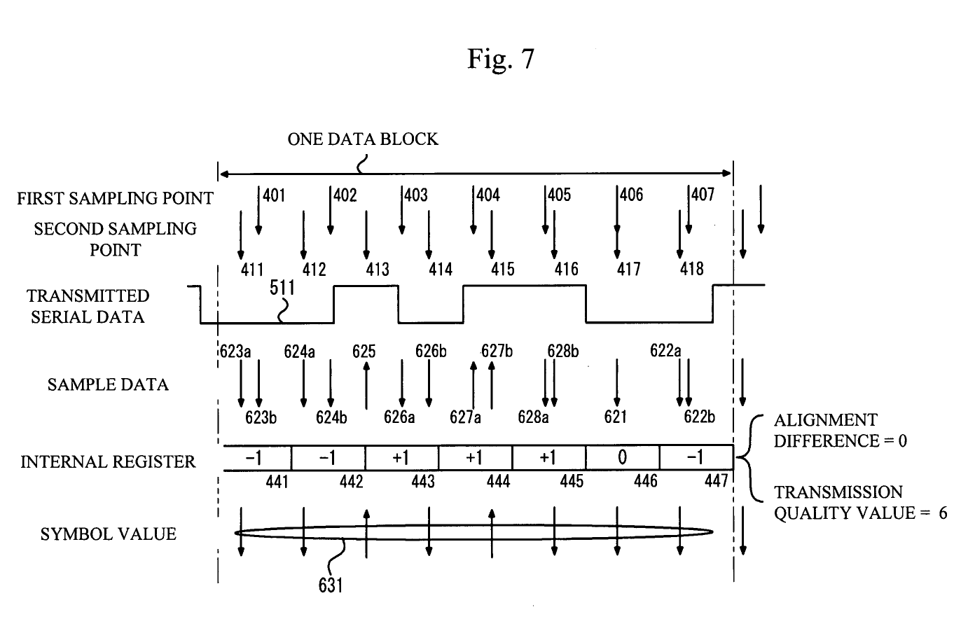

Moreover, a description will be given, with reference to FIG. 7, of the operation at the logical value level after the phase deviation shown in FIG. 6 is adjusted.

The alignment difference 340 that has been calculated is “+2”, and accordingly, the symbol-sampled clock signals 311 to be selected as the reference phase in the mDLL/mPLL 310 is shifted by “−2” in FIG. 7. This changes the clock signal to the clock signals 301 for alignment measurement having the sampling point 406 from the clock signals 301 for alignment measurement having the sampling point 401. At the same time, the values stored in the internal registers 441 through 447 are reset. In this case, the alignment difference 340 to be input into the mDLL/mPLL 310 may be obtained by averaging the values integrated for a given period.

Accordingly, the transmitted serial data 511 that has been input is sampled at the newly aligned first group and the second group of sampling points. As a result, the 14-bit sampled data (623a, 623b, 624a, 624b, 625, 626a, 626b, 627a, 627b, 628a, 628b, 621, 622a, and 622b) is output. Then, the alignment calculation circuit 330 calculates the alignment difference 340 again with the values respectively stored in the internal registers 441 through 447. Here, the sampling point of the reference phase is deviated by “−2”, and the calculated alignment difference 340 is “0”. The transmission quality value is “6”.

As mentioned, the phase relation between the transmitted serial data 111 and the symbol-sampled clock signals 311 are always adjusted with the calculation result obtained by the alignment calculation circuit 330, which makes it possible to detect the symbol value stably relative to the degraded signal waveform (such as skew) on the transmission line with a small sampling number.

The above-described calculation method is only an example of calculating the alignment difference 340 in the alignment calculation circuit 330. Another method other than the above-mentioned one is also capable of configuring the circuitry to evaluate the transmission quality with the sampled data to be sampled at the first and second groups of the sampling points.

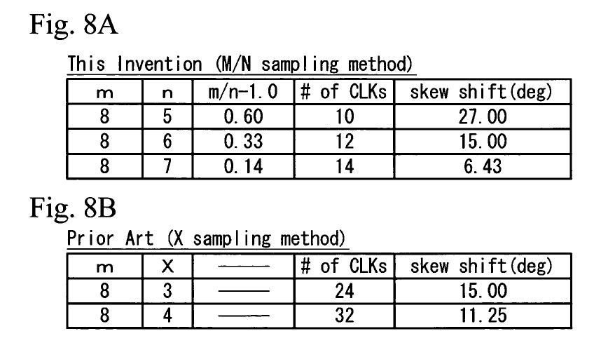

Additionally, FIG. 8A exemplifies a required minimum sampling number and a phase adjustment range of the transmitted serial data to be used in the sampling method that employs n-phase (n is a positive integer) clock signals (the clock signals generated in the first synchronizing circuit) and m-phase (m is a positive integer) clock signals (the clock signals generated in the second synchronizing circuit) in the above-mentioned receiver apparatus 3000. For comparison,

FIG. 8B also exemplifies another required minimum sampling number and the phase adjustment range of the transmitted serial data to be used in the X-time (X is a positive integer) oversampling scheme of conventional technique 1. The comparison of the two exhibits that the method of the present invention enables the phase adjustment finer than the three-time oversampling of conventional technique 1, by satisfying the following expression 1 if n is equal to or smaller than m.
m/n−1<⅓ (expression 1)

Also, n greater than m may be fine. If so, the following expression 2 should be satisfied so that the present invention can realize the phase adjustment finer than the three-time oversampling of conventional technique 1.
n/m−1<⅓ (expression 2)

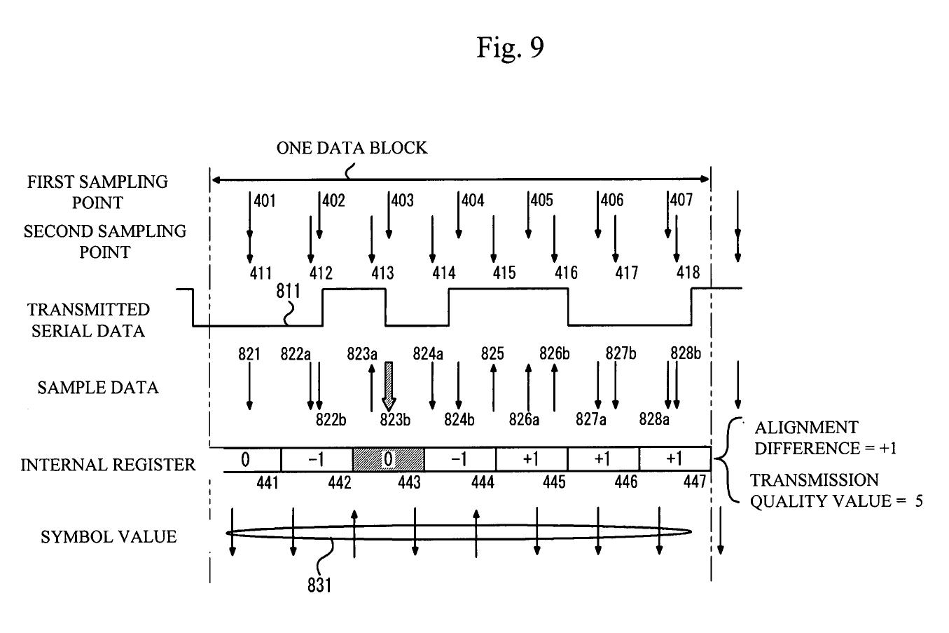

Next, a description will be given, with reference to FIG. 9, of the operation at the logical value level in the phase of the transmitted serial data to be input being deviated in an unbalanced manner from the phase of the sampling clock signals in the receiver apparatus 3000 shown in FIG. 4. This is an example of degradation caused by the difference in the signal delay period between the transmitted serial data and the clock signals to be input on the balanced transmission line and by the difference in the signal delay period on the two transmission lines included in the balanced transmission line.

In FIG. 9, transmitted serial data 811 that has been input is sampled at the first group of sampling points 401 through 407 and at the second group of sampling points 411 through 418. The sampling points 401 through 407 correspond to the clock signals 301 for alignment measurement, which are seven equal-phase clocks equally divided from a period of one data block 200. The second group of sampling points 411 through 418 correspond to the symbol-sampled clock signals 311, which are eight equal-phase clocks equally divided from a period of one data block 200 and one of the clocks is synchronized with one of the sampling points 401 through 407. As a result, 14-bit sampled data (821, 822a, 822b, 823a, 823b, 824a, 825, 826a, 826b, 827a, 827b, 828a, and 828b) is output.

Here, in FIG. 9, a trailing edge of the transmitted serial data 811 that has been input is deviated from the phase of the symbol-sampled clock signals 311. Therefore, the alignment difference 340 is calculated by the alignment calculation circuit 330 on the basis of the 14-bit sampled data 821, 822a, 822b, 823a, 823b, 824a, 825, 826a, 826b, 827a, 827b, 828a, and 828b that have been input. The result of the alignment difference 340 is “+1”, instead of “0”. According to the alignment difference 340, the phase alignment can be adjusted, by changing the selected symbol-sampled clock signal 311 that represents the reference phase in the mDLL/mPLL 310.

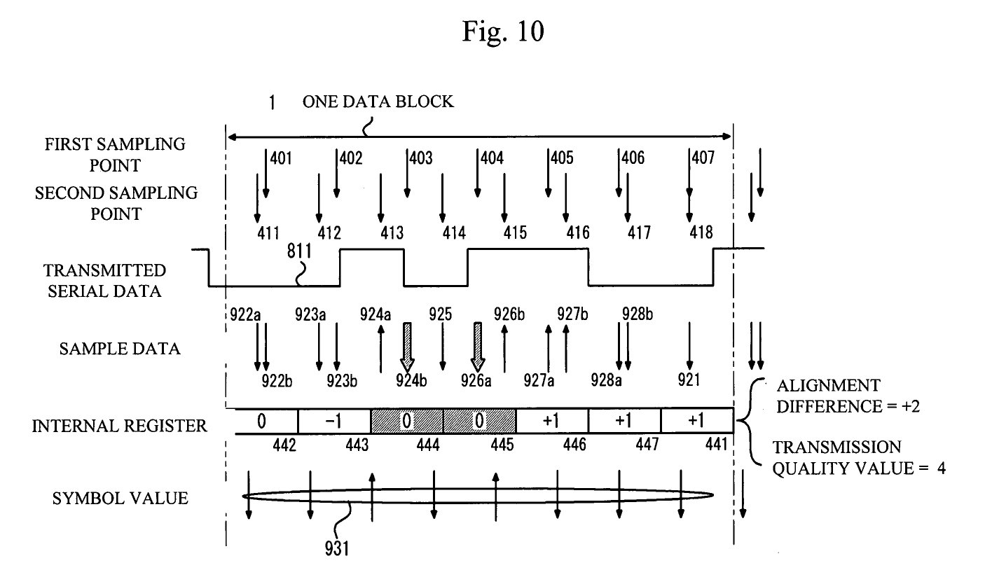

Further, a description will be given in more detail, with reference to FIG. 10, of the operation at the logical value level after the phase deviation shown in FIG. 9 is adjusted.

In FIG. 10, the clock signal to be selected in the mDLL/mPLL 310 as the reference phase is shifted by “−1”, because the calculated alignment difference 340 is “+1”. This changes the clock signal giving the reference phase to clock signal giving the sampling point 407 from the clock signal giving the sampling point 401. In this case, the alignment difference 340 to be input into the mDLL/mPLL 310 may be obtained by averaging the values integrated for a given period.

Therefore, the transmitted serial data 811 that has been input is sampled at the newly aligned sampling points, and a sampled data having 14 bits (822a, 822b, 823a, 823b, 824a, 825, 826a, 826b, 827a, 827b, 828a, 828b, and 821) is output. Here, the sampling point as the reference phase is shifted by “−1”, and accordingly the alignment difference 340 calculated by the alignment calculation circuit 330 is “0”.

The above-mentioned operation, however, results in “0” in the alignment difference 340, yet the transmission quality value of the sum of the absolute values respectively stored in the internal registers 441 through 447 is “4”, which is different from “6” representing excellent transmission quality. This does not exhibit that the transmitted serial data is just delayed from the symbol-sampled clock signals on the balanced transmission line (as shown in FIG. 6). This denotes that the value of the transmission quality becomes smaller even in the phase alignments that are matched, if the transmitted serial data having a degraded waveform is received such that the degraded waveform generates the difference in the delay periods between the two transmission lines included in the balanced transmission line.

In this manner, the receiver apparatus having the above-mentioned basic configuration is capable of determining an adjust direction of the phase alignment by calculating the sum of the values stored in the internal registers of the alignment calculation circuit, and is also capable of learning the quality of the transmission line by calculating the sum of the absolute values stored in the internal registers of the alignment calculation circuit.

An algorithm (the calculation method) of the circuit that evaluates the transmission quality with the use of the above-mentioned alignment calculation circuit 330 is just an example, and other examples are able to configuring the circuit that evaluates the transmission quality with the use of the sampled data sampled at the first and second groups of sampling points.

The quality of the transmission line may easily change dynamically on the generally used serial transmission line. In this case, if the quality of the transmission line (degradation level) can be measured in an easy manner, the transmission method can be selected according to the quality of the transmission line. For example, on the significantly degraded transmission line, the transmission circuit is controlled so that the transmitted serial data may be sent after the bit rate is lowered. This makes it possible to send the transmitted serial data stably. In the same manner, the receiving method may be selected to correspond to the quality of the transmission line. For example, on the significantly degraded transmission line, the gain of the first stage in the amplifier is increased or the waveform is equalized in the receiver apparatus. It is therefore possible to receive the transmitted serial data stably.

The basic configuration exemplified in the present invention has the ability to realize the receiver apparatus having the phase-adjusting capabilities equal to or more than the oversampling scheme described in conventional technique 1 with the clock signals less than those required for the oversampling scheme. Thus, it is possible to realize the performance equal to or more than the oversampling scheme, with less power consumption.

Moreover, the oversampling scheme described in conventional technique 1 makes it difficult to dynamically measure the quality of the transmitted serial data. However, according to the basic configuration of the present invention, it is possible to measure the quality easily and is applicable to the quality of the transmission line dynamically.

In the above description, the PLL (Phase Locked Loop circuit) or the DLL (Delay Locked Loop circuit) are employed in order to generate the n-phase clock signal in synchronization with the input clock signal, and in addition, the PLL or DLL is employed in order to generate the m-phase clock signal in synchronization with one clock signal selected from among the multiple clock signals having n phases. The present invention is applicable to and effective for another circuit that can generate multiphase clock signals having equal intervals. With respect to the number of multiphase clock signals, as far as n is not equal to m, any value used in n and m may be applicable as an alternate scheme of the basic configuration of the present invention.

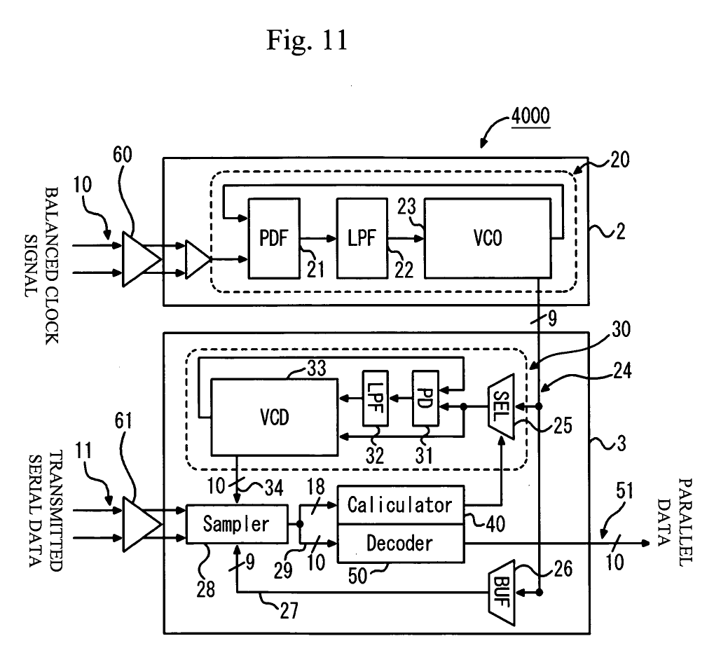

On the basic configuration of the present invention, there is provided a receiver circuit 4000 that receives one-channel transmitted serial data and has a functional block as shown in FIG. 11. In FIG. 11, 10 bits of the symbol bits are employed for the symbol-sampled clock signal. This enables to realize the phase-adjusting capabilities equal to or more than four-time oversampling scheme.

Referring to FIG. 11, the receiver apparatus 4000 is configured to include the common circuit 2 and the demodulator circuit 3. The common circuit 2 is composed of the first synchronizing circuit (PLL) 20.

The PLL 20 includes the phase comparator (PDF) 21, the lowpass filter (LPF) 22, and the voltage control oscillator (VCO) 23. The PLL 20 generates the clock signal 24 for measuring nine equal-phase alignments in synchronization with the balanced clock signal 10 (input clock signal) input through the analogue amplifier 60 having the gain-adjusting capabilities provided in the input circuit.

The demodulator circuit 3 is configured to include the second synchronizing circuit (DLL) 30, the clock select circuit (SEL) 25, the sampling register (sampler) 28, the alignment calculation circuit (calculator) 40, the decode circuit (decoder) 50, and the local buffer (BUF) 26. The DLL 30 is configured to include the phase detector (PD), the LPF 32, and the voltage control delay circuit (VCD) 33. The second synchronizing circuit (30) may be the DLL or PLL. However, if the PLL is included, the VCO is used instead of the VCD (33).

On the above-mentioned configuration, the DLL 30 generates 10 equal-phase symbol-sampled clock signals 34 in the VCD 33 so that at least one phase of the symbol-sampled clock signals may synchronize any one phase of the input clock signals, based on the clock signal 24 for alignment measurement that has been input via the clock select circuit 25 controlled by the phase-alignment calculation circuit 40, more specifically, based on a controlled voltage in the DLL 30 output from the LPF 32. The DLL 30, then, outputs the generated clock signals 34 to the sampling circuit 28. The clock signal 27 for measuring the nine equal-phase alignments and the balanced high-speed digital serial data (hereinafter, simply referred to as transmitted serial data) 11 are input into the sampling circuit 28, after the waveform of the clock signal 27 for alignment measurement is shaped in the local buffer 26 and the balanced high-speed digital serial data 11 is amplified by the analogue amplifier 61. The sampling circuit 28 outputs the sampling data 29 of 18 (=10+9−1) bits based on the input data and the clock signal.

The phase-alignment calculation circuit 40 calculates the alignment difference with the sampling data 29 that has been input from the sampling circuit 28, and gives feedback of the calculated value to the clock select circuit 25. On the other hand, the 10-bit data sampled in the symbol-sampled clock signal 34 from among the 18-bit sampling data 29 is output as the parallel data 51, after the bits are aligned in the decode circuit 50.

The demodulator circuit 3 equal in number to the channel is needed in order to simply apply the above-mentioned functional block to the receiver apparatus for receiving the transmitted serial data having multiple channels. This increases the circuit area substantially proportional to the increase in the channel number. Therefore, according to the present invention, the controlled voltage supplied from the second synchronizing circuit (PLL/DLL) is shared by the channels so as to reduce the increase in the circuit area, as will be described in the following embodiments of the present invention. This makes it possible to realize the receiving apparatus for the high-speed serial digital transmission signals having high performance with less power consumption. Hereinafter, preferred embodiments of the present invention will be described in detail, with reference to the accompanying drawings.

### First Embodiment

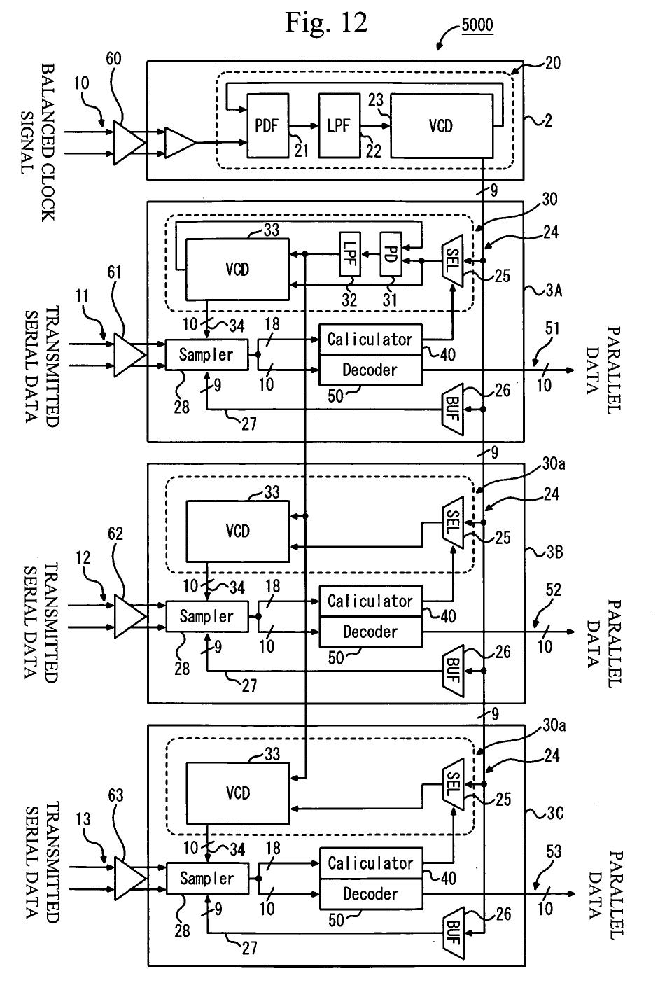

First, a description will be given, with reference to drawings, of a first embodiment of the present invention in detail. FIG. 12 is a functional block diagram showing the configuration of a receiver apparatus 5000 of the present invention. The receiver apparatus 5000, as shown in FIG. 12, receives the three-channel transmitted serial data, and has 10 bits of the symbol-sampled clock signals. This realizes the phase-adjusting capabilities equal to or greater than four times the oversampling scheme.

The receiver apparatus 5000 as shown in FIG. 12 is configured to include the common circuit 2 and three modulation circuits 3A, 3B, and 3C. On this configuration, the common circuit 2 is configured in the same manner as that described in FIG. 11, and respectively inputs the clock signals 24 for the alignment measurement into the demodulator circuits 3A, 3B, and 3C.

Any of the modulation circuits 3A, 3B, and 3C (here, the demodulator circuit 3A will be described) has the same configuration as the demodulator circuit 3 shown in FIG. 11. The other demodulator circuits (here, the demodulator circuits 3B and 3C) share the PD 31 and the LPF 32 in the DLL 30 of the demodulator circuit 3A. This eliminates the necessity of providing the PD 31 and the LPF 32 in a DLL 30a in the modulation circuits 3B and 3C.

The phase detector (PD) 31 and the lowpass filter (LPF) 32 that need a relatively large silicon area are thus shared by multiple demodulator circuits, and accordingly the circuit area can be drastically decreased. A description of the other configuration will be omitted, because the same configuration as that in FIG. 11 is applicable. The present invention, however, may not be limited to the configuration described with reference to FIG. 11, and another configuration may be applicable if the LPF having the relatively large silicon area can be employed in each demodulator circuit.

### Second Embodiment

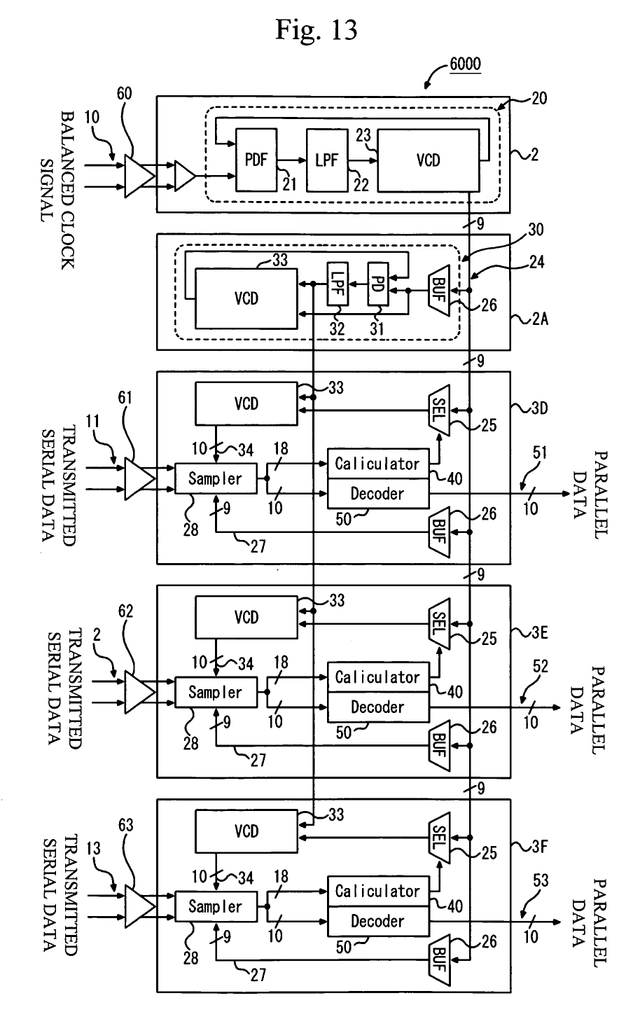

A description will be given, with reference to drawings, of a second embodiment of the present invention. FIG. 13 is a functional block diagram showing the configuration of a receiver apparatus 6000 of the present invention. The receiver apparatus 6000, as shown in FIG. 13, receives the three-channel transmitted serial data, and has 10 bits of the symbol-sampled clock signals. This realizes the phase-adjusting capabilities equal to or greater than four times the oversampling scheme.

The receiver apparatus 6000 of the present invention, shown in FIG. 13 is configured to include the common circuit 2, a common synchronizing circuit 2A, and three demodulator circuits 3D, 3E, and 3F. On this configuration, the common circuit 2 is configured in the same manner as described in FIG. 11.

The common synchronizing circuit 2A is configured to include the DLL 30, which is provided separately from the demodulator circuits 3D, 3E, and 3F so that the DLL 30 provided in the demodulator circuit 3 in FIG. 11 may be shared by multiple demodulator circuits. The common synchronizing circuit 2A includes the local buffer 26 that shapes the waveform of the clock signal 24 for alignment measurement to be input into the DLL 30. By providing the common synchronizing circuit 2A having the aforementioned configuration, the PD 31 and LPF 32 that require a relatively large silicon area can be eliminated in each of the demodulator circuits 3D, 3E, and 3F, and thereby the circuit area can be reduced significantly. A description of the configuration will be omitted, because the same configuration as shown in FIG. 11 may be applicable. The present invention, however, may not be limited to the configuration described with reference to FIG. 11, and another configuration is applicable if the LPF having a relatively large silicon area is employed in each of the demodulator circuits.

### Third Embodiment

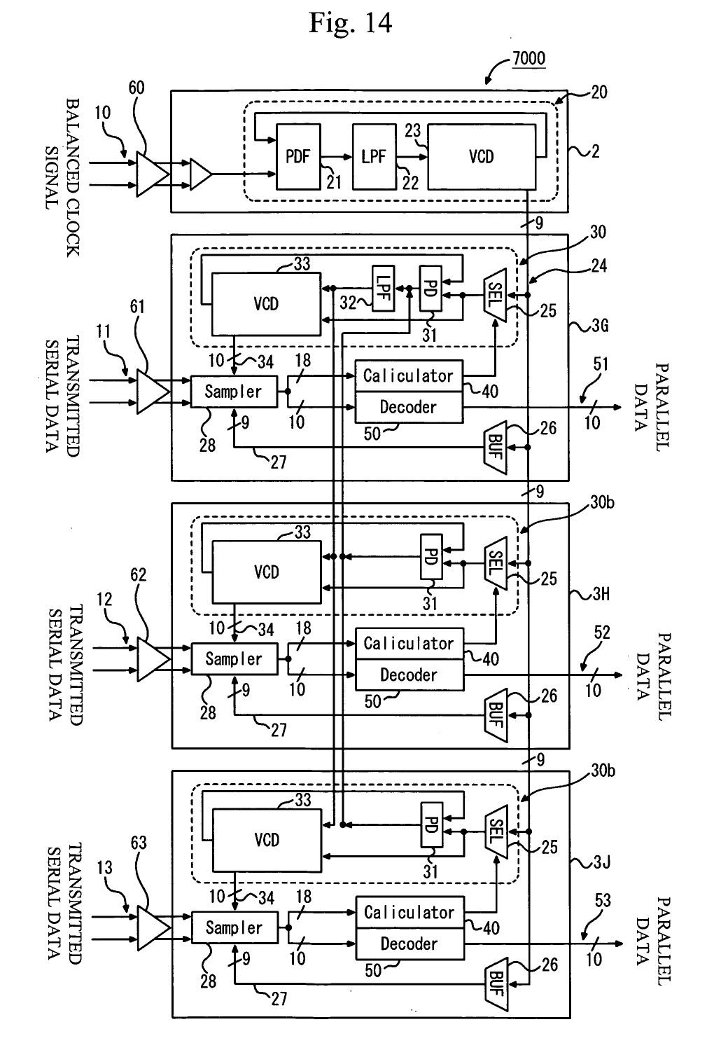

A description will be given, with reference to drawings, of a third embodiment of the present invention. FIG. 14 is a functional block diagram showing the configuration of a receiver apparatus 7000 of the present invention. The receiver apparatus 7000, as shown in FIG. 14, receives the three-channel transmitted serial data, and has 10 bits of the symbol-sampled clock signals. This realizes the phase-adjusting capabilities equal to or greater than four times the oversampling scheme.

The receiver apparatus 7000 of the present invention, shown in FIG. 14 is configured to include the common circuit 2 and three demodulator circuits 3G, 3H, and 3I. On this configuration, the common circuit 2 is configured in the same manner as shown in FIG. 11.

Any of the modulation circuits 3G, 3H, and 3I (here, the demodulator circuit 3G will be described) has the same configuration as the demodulator circuit 3 shown in FIG. 11. The other demodulator circuits (here, the demodulator circuits 3H and 3J) share the PD 31 in the DLL 30 of the demodulator circuit 3G. This eliminates the necessity of providing the LPF 32 in a DLL 30b in each of the modulation circuits 3H and 3J.

The lowpass filter (LPF) 32 that needs a relatively large silicon area is shared by multiple demodulator circuits, and the circuit area can be drastically decreased accordingly. A description of the other configuration will be omitted, because the same configuration as shown in FIG. 11 may be applicable. The present invention, however, may not be limited to the configuration described with reference to FIG. 11, and may be applicable to any configuration in which the LPF having a relatively large silicon area is employed for each demodulator circuit.

The present invention is not limited to the above-mentioned embodiments, and other embodiments, variations and modifications may be made without departing from the scope of the present invention.

The present invention, as described above, provides the receiver circuit in which at least one part of the circuits is shared, and thereby it is possible to avoid an increase in the circuit area. Moreover, the receiver apparatus having the above-mentioned effect can be realized with the characteristics of low power consumption.

What is claimed is:

1. A receiver apparatus having a demodulator circuit that demodulates transmitted serial data into parallel data by sampling the transmitted serial data on the basis of first and second clock signals having different numbers of clocks to be output in synchronization with a cycle of a transmitted clock, said receiver apparatus comprising:
a first synchronizing circuit generating the first clock signal synchronized with the cycle of the transmitted clock; and
a second synchronizing circuit generating the second clock signal synchronized with the cycle of the transmitted clock and having a number of clocks different from that of the first clock signal,
wherein the demodulator circuit comprises the second synchronizing circuit, a sampling register storing sampled data obtained by sampling the transmitted serial data on the basis of the first and second clock signals, a difference calculating circuit that calculates a difference between the transmitted serial data and the input clock signal on the basis of the sampled data, and a clock select circuit that adjusts a phase of a symbol-sampled signal on the basis of the difference.

2. A receiver apparatus having at least two demodulator circuits that demodulate transmitted serial data into parallel data by sampling the transmitted serial data on the basis of first and second clock signals having different numbers of clocks to be output in synchronization with a cycle of a transmitted clock, said receiver apparatus comprising:
a first synchronizing circuit generating the first clock signal synchronized with the cycle of the transmitted clock; and
a plurality of second synchronizing circuits generating the second clock signal synchronized with the cycle of the transmitted clock and having a number of clocks different from that of the first clock signal;
wherein:
each of said at least two demodulator circuits comprises any one of said plurality of second synchronizing circuits, a sampling register storing sampled data obtained by sampling the transmitted serial data on the basis of the first and second clock signals, a difference calculating circuit that calculates a difference between the transmitted serial data and the input clock signal on the basis of a sampled data, and a clock select circuit that adjusts a phase of a symbol-sampled signal on the basis of the difference; and
a lowpass filter circuit included in one of said at least two modulator circuits is shared by another modulator circuit as the lowpass filter.

3. The receiver apparatus as claimed in claim 1, wherein at least two said second synchronizing circuits share a phase detection circuit.

4. The receiver apparatus as claimed in claim 1, wherein the first synchronizing circuit inputs the first clock signal into at least two said synchronizing circuits.

5. The receiver apparatus as claimed in claim 1, further comprising a voltage control oscillator that generates the second clock signal on the basis of a controlled voltage output from the lowpass filter circuit.

6. The receiver apparatus as claimed in claim 1, further comprising a voltage control delay circuit that generates the second clock signal on the basis of a controlled voltage output from the lowpass filter circuit.

7. The receiver apparatus as claimed in claim 1, further comprising a phase locked loop circuit or a delay locked loop circuit that includes the lowpass filter to be shared.

8. The receiver apparatus as claimed in claim 1, wherein the first synchronizing circuit includes a phase locked loop circuit, and the second synchronizing circuit includes a delay locked loop circuit having the lowpass filter to be shared.

9. The receiver apparatus as claimed in claim 1, wherein the second synchronizing circuit generates the second clock signal having an n number of phases that satisfies n/m−1<⅓, where the first clock signal has the n number of phases and the second clock signal has an m number of phases.

10. The receiver apparatus as claimed in claim 1, wherein the second synchronizing circuit generates the second clock signal having an m number of phases that satisfies m/n−1<⅓, where the first clock signal has an n number of phases and the second clock signal has the m number of phases.

11. The receiver apparatus as claimed in claim 1, wherein the clock select circuit selects multiple clocks synchronized with the transmitted clock and deviated in phase to be the input clock signal of the second synchronizing circuit, on the basis of an output from the difference calculating circuit in order to adjust a phase relation of the transmitted clock in synchronization with the cycle of the transmitted clock.

12. The receiver apparatus as claimed in claim 1, further comprising a quality evaluation circuit that evaluates a quality value of the transmitted serial data on the basis of the sampling data.

13. A receiver apparatus comprising:
a first synchronizing circuit generating a first clock signal synchronized with a cycle of a transmitted clock; and
a plurality of demodulator circuits,
wherein:
each of said plurality of demodulator circuits includes a second synchronizing circuit generating the second clock signal synchronized with the cycle of the transmitted clock and having a number of clocks different from that of the first clock signal, a sampling register storing sampled data obtained by sampling the transmitted serial data on the basis of the first and second clock signals, a difference calculating circuit that calculates a difference between the transmitted serial data and the transmitted clock on the basis of the sampled data, and a clock select circuit that selects multiple clocks synchronized with the transmission clock and deviated in phase to be the input clock signal of the second synchronizing circuit, on the basis of an output from the difference calculating circuit in order to adjust a phase relation of the transmission clock while synchronized with the cycle of the transmitted clock; and
at least one of the second synchronizing circuit included in each of said plurality of demodulator circuits generates the second clock signal on the basis of a controlled voltage output from a lowpass filter circuit included in the second synchronizing circuit in another demodulator circuit.

14. A receiver apparatus comprising:
a first synchronizing circuit generating a first clock signal synchronized with a cycle of a transmitted clock; and
a plurality of demodulator circuits,
wherein:
each of said plurality of demodulator circuits includes a second synchronizing circuit generating the second clock signal synchronized with the cycle of the transmitted clock and having a number of clocks different from that of the first clock signal, a sampling register storing sampled data obtained by sampling the transmitted serial data on the basis of the first and second clock signals, a difference calculating circuit that calculates a difference between the transmitted serial data and the transmitted clock on the basis of the sampled data, and a clock select circuit that selects multiple clocks synchronized with the transmission clock and deviated in phase to be the input clock signal of the second synchronizing circuit, on the basis of an output from the difference calculating circuit in order to adjust a phase relation of the transmission clock while the second synchronizing circuit is being synchronized with the cycle of the transmitted clock; and
at least one of the second synchronizing circuit included in each of said plurality of demodulator circuits includes a lowpass filter circuit, supplies an output from the lowpass filter circuit to another demodulator circuit, and generates the second clock signal on the basis of a controlled voltage output from the lowpass filter circuit included in the second synchronizing circuit in another demodulator circuit.

15. A receiver apparatus comprising:
a first synchronizing circuit generating a first clock signal synchronized with a cycle of a transmitted clock;
a controlled voltage output circuit that outputs a controlled voltage to generate a second clock signal synchronized with the cycle of the transmitted clock and having a number of clocks different from that of the first clock signal; and
a demodulator circuit that includes a second synchronizing circuit that generates a second clock signal on the basis of the controlled voltage output from the controlled voltage output circuit, a sampling register storing sampled data obtained by sampling the transmitted serial data on the basis of the first and second clock signals, a difference calculating circuit that calculates a difference between the transmitted serial data and the transmitted clock on the basis of the sampled data, and a clock select circuit selects multiple clocks synchronized with the transmitted clock and deviated in phase to be the input clock signal of the second synchronizing circuit, on the basis of an output from the controlled voltage output circuit in order to adjust a phase relation of the transmitted clock while synchronized with the cycle of the transmitted clock.
